(19) United States
(12) Patent Application Publication
(10) Pub. No.: US 2007/0096895 A1
(43) Pub. Date: May 3, 2007

(54) Mass notification controller system X 4

(76) Inventor: William Franklin Sneade JR., Petersburg, VA (US)

Correspondence Address: Stacey Kingsbury, 10054 Vista Court, Myersville, MD, 21773, US

(21) Appl. No.: 11/263,238

(22) Filed: Oct. 31, 2005

(51) Int. Cl. G08B 29/00; G08B 9/00

(52) U.S. Cl. 340/506; 340/286.02

(57) ABSTRACT

The Mass Notification System X 4 is the first product that actually meets and addresses the Department of Defense's requirements for a Mass Notification System. Furthermore, it meets the recommendations of the Unified Facilities Criteria (UFC) prescribed by MIL-STD 3003 as applies to the Military Departments, the Defense Agencies and the DOD Field activities in accordance with USD Memorandum dated May 2002. It meets the requirements to provide mass notification in compliance with UFC 4-010-01, DOD Minimum Antiterrorism Standards for Buildings. In short, the Mass Notification System X 4 is the only product that is capable of providing real time information through the integration and control of existing notification assets to all building occupants or personnel in the work area and immediate vicinity of a building during emergency situations.

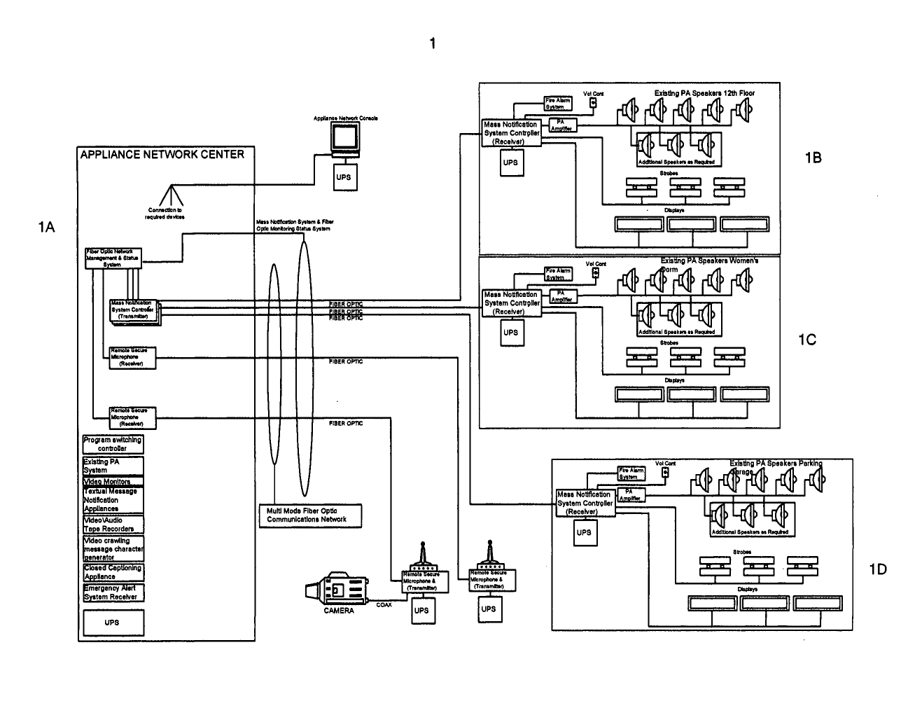

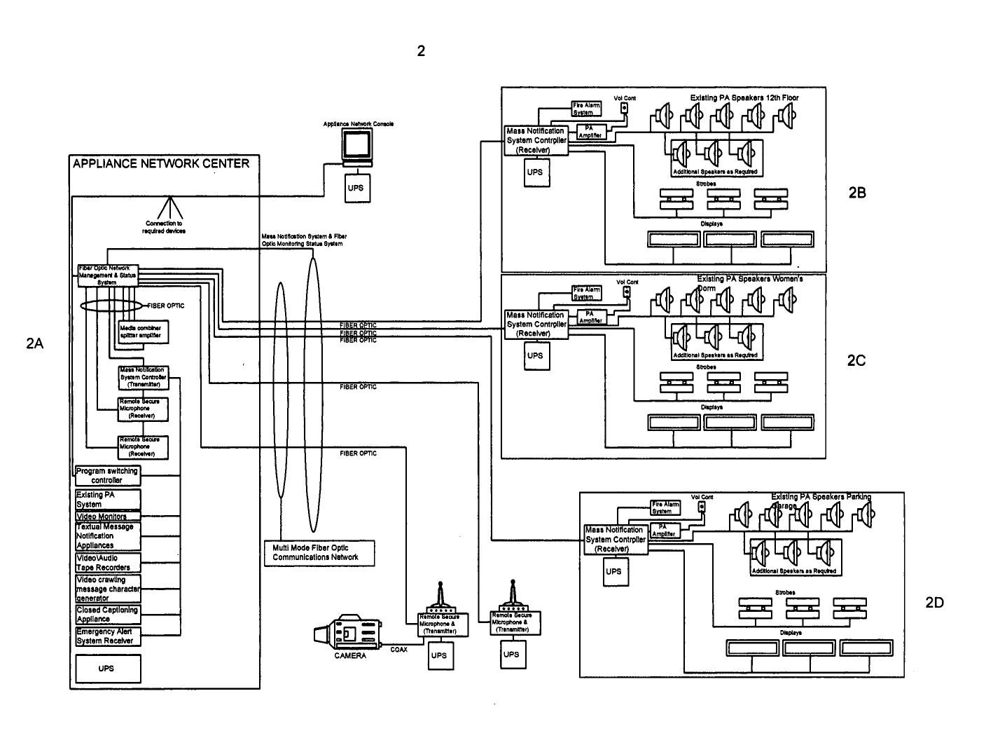

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

The Mass Notification Controller System X 4 has been working for some five years now. It is relative to building(s)/base infrastructure. It is a whole base system under control of a primary and a secondary control center as recommended by the Unified Facilities Criteria (UFC) prescribed by MIL-STD 3003 as applies to the Military Departments, the Defense Agencies, and the DOD Field Activities in accordance with USD(AT&L) Memorandum dated May 2002. This meets the requirements to provide mass notification in compliance with UFC 4-010-01, DOD Minimum Antiterrorism Standards for Buildings. The Mass Notification System has the capability to provide real time information to all building occupants or personnel in the work area and the immediate vicinity of a building/bay during emergency situations to reduce the risk of mass casualties. The Mass Notification System is the first and only product to address the UFC and DOD standards for antiterrorism.

### BRIEF SUMMARY OF THE INVENTION

The Mass Notification System Controller (MNSC) when activated, integrates and controls existing Appliance Network assets. When activated automatically via an EAS receiver or manually by keying a secure microphone, the MNSC will seize control of the Appliance Network such as PA Systems, video monitors, textual message notification appliances, video editors, audio tape recorders, Emergency Alert Broadcast Systems (EAS), video crawling message character generators, closed captioning devices, video and audio recording equipment to provide immediate real time information to all building(s) occupants and or personnel in the work area and the immediate vicinity of the building(s) during emergency situations to reduce the risk of mass causalities. This summery details each of four devices connected with the invention.

The Mass Notification Controller Transmitter (MNCT) is the first part and is located in the Appliance Network Center (ANC) and transmits all information from the (ANC) to the receivers (second part) located at desired locations that are to receive emergency information that the ANC is equipped for and capable of sending via the MNCT.

The Mass Notification Controller Receiver (MNCR) is the second part and receives information from the ANC via the MNCT and applies it to devices such as speakers, video monitors, and textual message notification appliances. The Existing PA system will also operate through this receiver in order that it can be interrupted when an emergency message is sent. The MNCR will cause the PA system volume controls to be bypassed to a preset volume and normal PA operation will be interrupted when an emergency message is sent from the ANC. Normal video and associated audio (if installed) will also be interrupted and replaced with any video and/or audio associated with the emergency message. It will connect a siren attention signal of approximately three seconds over the speakers and turn on a strobe to alert the hearing impaired when activated.

The Remote Secure Microphone Transmitter (RSMT) (third part) will activate the MNCT via the Remote Secure Microphone Receiver (RSMR) (fourth part). The RSMT allows audio emergency messages and video, if equipped, to be transmitted to all MNCR locations. If so equipped the message will be sent to other video devices such as textual message notification appliances, and VCRs.

The advantages of the Mass Notification System Controller are as follows:
The invention of the Mass Notification System Controller meets and exceeds the Department of Defense (DOD) UFC Requirements specified in UFC 4-010-01, Minimum Antiterrorism Standards for Buildings.
Provides real time information to all building occupants or personnel in the work area and the immediate vicinity of a building(s) during emergency situations to reduce the risk of mass casualties.
Temporarily deactivates audible fire alarm notification appliances while delivering voice message to ensure they are intelligible.

Integrates existing Network Notification Appliances
Overrides existing Public Address system on/off and volume controls to assure delivery of real time information
Flexible and expandable for easy use and growth
Provides notification features for the Blind and Hearing impaired
Ability to broadcast Civil Emergency Messages, 28 different emergency weather alerts and KU satellite programs to overhead speakers with text to monitors in all buildings
Utilizes existing notification devices

### BRIEF DESCRIPTION OF THE SEVERAL VIEWS OF THE DRAWING

1A: The Appliance Network Control Center showing the location of the Mass Notification System Controller (First Part of the Invention) and its connection to the Fiber Optic Network.

1B, 1C, 1D: Illustrates the placement and connection to the Fiber Optic Network and the existing Appliance assets of the Mass Notification System Controller Receiver (Second Part of the Invention)

2A: The Appliance Network Control Center showing the location of the Mass Notification System Controller (First Part of the Invention) and its connection to the Fiber Optic Network and the connection and control of all other Appliance assets terminating in the Appliance Network Center.

2B, 2C, 2D: Illustrates the placement and connection to the Fiber Optic Network and the existing Appliance assets of the Mass Notification System Controller Receiver (Second Part of the Invention)

### DETAILED DESCRIPTION OF THE INVENTION

The abstract provided herein will show how this invention meets and exceeds the DOD requirements to provide a Mass Notification System. The DOD requires a Mass Notification system that must have at a minimum the capability to provide real-time information to all building occupants or personnel in the work area and the immediate vicinity of a building, bay, floor, or balcony during emergency situations to reduce the risk of mass causalities. The invention is not based solely around use by the DOD and can be utilized in a commercial capacity in support of Homeland Security. Examples are where it might be used in commercial office buildings, college campuses, theaters, theme parks, athletic arenas, and other like areas of mass occupancy.

At this time the invention will be referred to as the Mass Notification System Controller (MNSC). The MNSC consist of one master controller capable of transmitting signals and messages from selected data collecting appliances to any number of MNSC receivers via a single mode or multi mode fiber optic communication network. The MNSC master controller will accept live messages from remote MNSC Secure microphones. The MNSC remote microphones operate from separate MNSC devices for obvious reasons that will be explained later in this abstract.

Depending on the number and size of selected appliances that will be used in a configuration they will most likely be housed in a relay rack and stored in a secure room or closet along with an adequately sized UPS. This will be called the Appliance Network Center (ANC) for the sake of this abstract.

The Appliance Network Console will usually be located in an area that is normally always manned. Such areas would be the security section or in an area where responsibility for its control is assigned. The console will be capable of remotely controlling all controllable appliances of the ANC when the ANC is not under control of the MNSC by a secure microphone or automatically controlled appliances such as an EAS. Secure microphones will always have priority control over the MNSC, however if the ANC is so equipped messages received via an EAS can be recorded and will be immediately played back after release of the MNSC by the Secure microphone. In the case of the reception of an EAS message while the secure microphone has control of the MNSC the EAS will attempt to take control of the MNSC and at the same time start the recording appliance. Since the Secure microphone has priority control if the secure microphone is released during the reception of the EAS message the EAS will take immediate control of the MNSC and the EAS reception will be heard from that point in the live EAS reception to its end. At that point the EAS will release the MNSC. The entire EAS message as recorded will be played from the beginning under the control of the console. If the Secure microphone is released after the end of the EAS message is completed the MNSC will be accessed and the message will be played. The recording appliance can be queued by the console to continue replaying the recorded message.

The following will show that when the MNSC is activated either by the network console, by keying a secure microphone or automatically by an EAS receiver or other automatic appliance will take control of the ANC and will:
Provide control over an existing ANC consisting of such appliances as, PA systems, video monitors, textual message notification appliances, video editors, audio tape recorders, Emergency Alert Broadcast Systems (EAS), video crawling message character generators, closed captioning devices, video and audio recording equipment.
Provide MNSC Secure Microphones for live voice emergency messages. Secure microphones are associated only with the MNSC and will not interfere with existing PA systems normal microphone operation when the MNSC is not activated. Secure microphones when keyed-up activate the MNSC. Any number of secure microphones can be used with the MNSC, however no two can be used at the same time. Secure microphones can be placed in remote locations away from the console and the ANC. Secure microphones stand-alone and can operate at most any remote location. All secure microphones are equipped with a connection to support a video camera also under the control of the MNSC. Secure microphones will usually be assigned levels of priority due to locations of intended use. Normally a secure microphone will be located at the Appliance Console, however that is not necessary, if so desired, should be considered in the priority assignment of secure microphones. No secure microphone is required at the ANC unless the ANC were equipped with certain appliances that are intended to be operated manually during the delivery of an emergency message then a priority ONE secure microphone would normally be assigned at that location. If the priority ONE microphone is required at a location remote to the ANC a secure microphone of lower priority can be assigned to the ANC. If this is not the case any secure microphone can be designated to deliver the emergency message. For example if the existing ANC supports video monitors a secure microphone equipped with a camera can be located near the work area of a “signer”. If this method is elected to accommodate the hearing impaired then this operation can only be accomplished from the location of the secure microphone to be used to give the emergency message. Caution: If a lower priority microphone is in operation the operation of a higher priority microphone will terminate the lower priority microphone control and take over the activation of the MNSC. This is done to prevent conflicting messages and insure emergency messages are intelligible to all.
Provide operation of hearing impaired appliances. If the existing ANC supports video monitors simultaneous crawling messages produced by a video crawling message generator and closed captioning devices, and videotape can be used to aid the hearing impaired. If textual message notification appliances are used textual message generators installed in the ANC will aid the hearing impaired. All under the control of the MNSC.
Activate textual message notification appliances, video editors, audio and video tape audio and video tape recorders, if equipped in the ANC can be used for playback and/or recording of the emergency message.
Provide VCR and audio recording and playback of emergency messages generated when using the secure microphone and playing of prerecorded messages selected from an assortment of audio and audio/video messages on hand.
Provide a siren signal of approximately three seconds (variable) to call attention to a forthcoming emergency message. All secure microphones are equipped with an indicator to make the user aware of the operation of the siren signal. This indicator is required to prevent the operator from starting the emergency message until the siren signal has cleared.
Provide existing PA system volume control bypass and set the Mass Notification System volume to a pre-set level and remove any background music and any other sources of input to the PA system in it's normal operational mode. Bypass indicates that attempts to lower or raise the existing PA system volume during MNSC activation will not change the pre-set bypass volume supplied to the speakers by the MNSC when activated. The pre-set volume insures emergency messages are intelligible to all.
Activate strobe lights to alert the hearing impaired. If the existing ANC is equipped to broadcast to video monitors, textual message notification appliances, video crawling message character generators, the strobe lights can be located near each of these devices.
Provide automatic switchover to an Emergency Alert System (EAS). The EAS is a radio receiver set to receive certain emergency messages. Normally used by the National Weather Service to provide weather warnings most receivers have a National Emergency Action Notification channel. In addition the EAS appliances have additional inputs to accommodate the monitoring of emergency broadcast transmitted by radio and TV stations. In the event an emergency message is received by the EAS from any source the MNSC will take control of the ANC and the emergency message will be automatically announced over the Mass Notification System speakers without any manual intervention. The only exception will be if a secure microphone has control of the MNSC as defined above. Strobe lights will be activated. A scrolled message provided by the EAS will be seen on video monitors and/or textual message notification appliances if equipped.

1. The invention of the Mass Notification System Controller meets and exceeds the Department of Defense (DOD) UFC Requirements specified in UFC 4-010-01, Minimum Antiterrorism Standards for Buildings. It provides real time information to all building occupants or personnel in the work area and the immediate vicinity of a building(s) during emergency situations to reduce the risk of mass casualties. It temporarily deactivates audible fire alarm notification appliances while delivering voice message to ensure they are intelligible. It integrates existing Network Notification Appliances and overrides existing Public Address system on/off and volume controls to assure delivery of real time information. The system is flexible and expandable for easy use and growth while providing notification features for the Blind and Hearing impaired. It has the ability to broadcast Civil Emergency Messages, 28 different emergency weather alerts and KU satellite programs to overhead speakers with text to monitors in all buildings and utilizes existing notification devices.
